(19) United States
(12) Patent Application Publication
(10) Pub. No.: US 2014/0160175 A1
(43) Pub. Date: Jun. 12, 2014

(54) DISPLAY APPARATUS AND CONTROL METHOD THEREOF

(71) Applicant: Canon Kabushiki Kaisha, Tokyo (JP)

(72) Inventor: Kiyohiro Uemura, Machida-shi (JP)

(73) Assignee: Canon Kabushiki Kaisha, Tokyo (JP)

(21) Appl. No.: 14/096,768

(22) Filed: Dec. 4, 2013

(30) Foreign Application Priority Data
Dec. 11, 2012 (JP) 2012-270574
Oct. 15, 2013 (JP) 2013-214562

(51) Int. Cl. G09G 3/14

(52) U.S. Cl. CPC G09G 3/14
USPC 345/690; 345/102

(57) ABSTRACT

A display apparatus according to the present invention includes: a backlight; a display panel configured to transmit light from the backlight at a transmittance based on an input image signal; a backlight sensor configured to detect light from the backlight; a external light sensor configured to detect external light of the display apparatus; and a control unit configured to control an amount of luminescence of the backlight based on a detection value of the backlight sensor and a detection value of the external light sensor.

### BACKGROUND OF THE INVENTION

1. Field of the Invention

The present invention relates to a display apparatus and a control method thereof.

2. Description of the Related Art

A conventional problem is the change of brightness of a backlight caused by environmental change, including temperature change of the backlight and aging deterioration of a backlight due to use over a long period of time. Therefore in order to reduce the change of brightness and unevenness of the backlight, a technique to perform feedback control of amount of luminescence of the backlight has been proposed, so that the detection value of the optical sensor (backlight sensor) disposed in the display apparatus becomes constant.

A backlight sensor is a sensor that detects light from the backlight. Actually, however, synthesized light of the light from the backlight and other light (e.g. external light transmitted into the display apparatus via the display panel) is detected by the backlight sensor. If external light is sufficiently less than the light from the backlight, the influence of the external light on the detection value of the backlight sensor can be ignored. Otherwise the amount of luminescence of the backlight cannot be accurately feedback-controlled because of the influence of the external light on the detection value of the backlight sensor.

Recently display panels having high light utilization efficiency are becoming popular. For example, the light utilization efficiency of a micro electro mechanical systems (MEMS) shutter panel is as high as 60% to 80%.

The light utilization efficiency of standard liquid crystal panels is as low as 2% to 3%. The light utilization efficiency here refers to a ratio of the light emitted from the display panel (light of the backlight after being transmitted through the display panel) with respect to the light from the backlight when the aperture ratio of the display panel (display element of the display panel) is at the maximum.

In the case of a MEMS display apparatus (display apparatus having a MEMS shutter panel), if the amount of light emitted from the display panel is the same as the case of a liquid crystal display apparatus (display apparatus having a liquid crystal panel), the amount of luminescence of the backlight becomes lower, approximately 1/20 to 1/40, compared with the case of the liquid crystal display apparatus. The amount of external light after being transmitted through the display panel becomes higher, approximately 25 times to 50 times, compared with the case of the liquid crystal display apparatus.

Therefore in the case of a MEMS display apparatus, the ratio of the external light to the light from the backlight is higher than the case of the liquid crystal display apparatus. As a result, the light from the backlight cannot be accurately detected, and the amount of luminescence of the backlight cannot be feedback-controlled accurately.

Thus in the case of a display apparatus having a display panel of which light utilization efficiency is high, light from the backlight cannot be accurately detected, and the amount of luminescence of the backlight cannot be feedback-controlled accurately.

Japanese Patent Application Laid-Open No. 2009-139784 discloses a method for accurately detecting the external light in the display apparatus. In concrete terms, according to the display apparatus disclosed in Japanese Patent Application Laid-Open No. 2009-139784, a external light sensor (a sensor for detecting external light) is disposed on a thin film transistor (TFT). An influence quantity of stray light (for example, light emitted from a backlight into a external light sensor) on the detection value of the external light sensor is calculated according to the brightness of the backlight, and the detection value of the external light sensor is corrected based on the influence quantity.

It is possible to calculate the influence quantity of the external light on the detection value of the backlight sensor according to the detection value of the external light sensor, and correct the detection value of the backlight sensor based on the influence quantity by applying the technique disclosed in Japanese Patent Application Laid-Open No. 2009-139784.

However the transmittance of the display panel (transmittance when the external light and light from the backlight transmit through the display panel) depends on the input image signal, hence the influence quantity also depends on the input image signal. This means that, even if the technique disclosed in Japanese Patent Application Laid-Open No. 2009-139784 is used, the influence quantity cannot be accurately calculated, and therefore the detection value of the backlight sensor cannot be accurately corrected.

### SUMMARY OF THE INVENTION

The present invention provides a technique that can accurately reduce the influence of the external light on the detection value of the backlight sensor, and can accurately detect light from the backlight.

The present invention in its first aspect provides a display apparatus including a backlight and a display panel configured to transmit light from the backlight at a transmittance based on an input image signal,

the display apparatus comprising:

a backlight sensor configured to detect light from the backlight;

a external light sensor configured to detect external light of the display apparatus; and

a control unit configured to control an amount of luminescence of the backlight based on a detection value of the backlight sensor and a detection value of the external light sensor.

The present invention in its second aspect provides a display apparatus including a backlight and a display panel configured to transmit light from the backlight at a transmittance based on an input image signal,

the display apparatus comprising:

a backlight sensor configured to detect light from the backlight;

a external light sensor configured to detect external light of the display apparatus; and

a correcting unit configured to correct a detection value of the backlight sensor based on a detection value of the external light sensor.

The present invention in its third aspect provides a method of controlling a display apparatus including a backlight, a display panel configured to transmit light from the backlight at the transmittance based on an input image signal, a backlight sensor configured to detect light from the backlight, and a external light sensor configured to detect external light of the display apparatus,

the method comprising:

acquiring a detection value of the backlight sensor and a detection value of the external light sensor; and

controlling an amount of luminescence of the backlight based on the detection value of the backlight sensor and the detection value of the external light sensor.

The present invention in its fourth aspect provides a method of controlling a display apparatus including a backlight, a display panel configured to transmit light from the backlight at a transmittance based on an input image signal, a backlight sensor configured to detect light from the backlight, and a external light sensor configured to detect external light of the display apparatus,

the method comprising:

acquiring a detection value of the backlight sensor and a detection value of the external light sensor; and

correcting the detection value of the backlight sensor based on the detection value of the external light sensor.

According to the present invention, the influence of the external light on the detection value of the backlight sensor can be accurately reduced, and light from the backlight can be accurately detected.

Further features of the present invention will become apparent from the following description of exemplary embodiments with reference to the attached drawings.

### BRIEF DESCRIPTION OF THE DRAWINGS

FIGS. 1A and 1B are schematic diagrams depicting an example of a display apparatus according to Embodiment 1;

FIG. 2 is a block diagram depicting a configuration of a display control unit according to Embodiment 1;

FIG. 3 is a flow chart depicting an example of operation of the display control unit;

FIG. 4 is a flow chart depicting backlight control value correction processing according to Embodiment 1;

FIG. 5 is a flow chart depicting an example of backlight detection value correction processing;

FIG. 6 is an example of a pixel external light transmittance table;

FIG. 7 is an example of an influence quantity table;

FIG. 8 is a block diagram depicting a configuration of a display control unit according to Embodiment 2;

FIG. 9 is a flow chart depicting backlight control value correction processing according to Embodiment 2; and

FIG. 10 is an example of a backlight reflected light ratio table.

### DESCRIPTION OF THE EMBODIMENTS

### Embodiment 1

Embodiment 1 of the present invention will now be described.

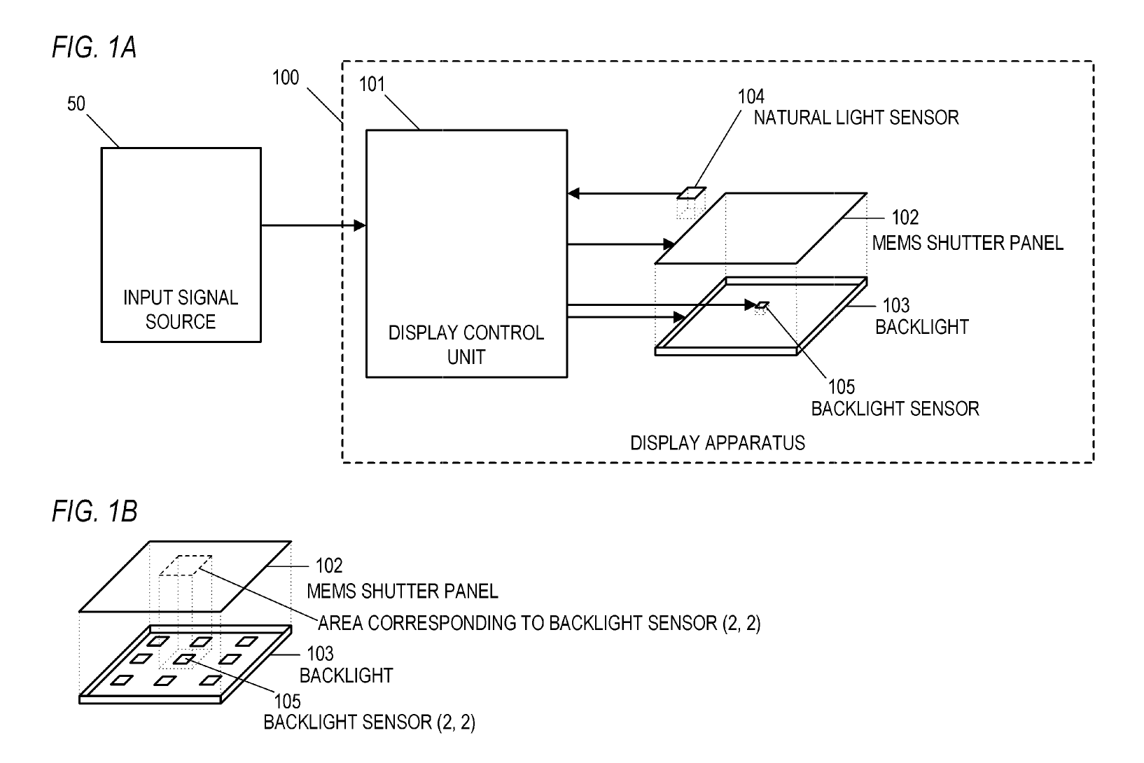

FIG. 1A is a schematic diagram depicting an example of the configuration of a display apparatus according to the present embodiment.

The display apparatus 100 includes a display control unit 101, a MEMS shutter panel 102, a backlight 103, a external light sensor 104 and a backlight sensor 105.

An input signal source 50 is an apparatus that outputs an image signal. The input signal source 50 is, for example, a storage apparatus that stores an image signal (image data). The input signal source 50 may be a storage apparatus (storage apparatus that stores an image signal) disposed in the display apparatus 100.

The backlight 103 is a light source apparatus that irradiates light onto a rear face of the MEMS shutter panel 102. Light emitting diodes (LEDs), organic electro-luminescence (EL) elements and cold-cathode tubes, for example, can be used for the light source of the backlight 103.

The MEMS shutter panel 102 is a display panel that displays an image by transmitting light from the backlight at a transmittance based on an input image signal (image signal that is inputted to the display apparatus). In concrete terms, the MEMS shutter panel 102 has a MEMS shutter for each pixel. An aperture ratio of the MEMS shutter is controlled based on the input image signal. Here the aperture ratio is a ratio of the open time to one frame time (open time per frame).

The display panel is not limited to the MEMS shutter panel. The display panel can be any display panel that displays an image by transmitting light from the backlight. For example, the display panel may be a liquid crystal panel that has a plurality of liquid crystal elements. The aperture ratio of each liquid crystal element may be controlled based on the input image signal.

The external light sensor 104 is a sensor for detecting the external light of the display apparatus 100. A detection surface of the external light sensor 104 is disposed on the front surface (outside the MEMS shutter panel 102) of the display apparatus 100. For example, the external light sensor 104 is an illuminance sensor, and a detection value of the external light sensor 104 (external light detection value) indicates illuminance.

The backlight sensor 105 is a sensor for detecting light from the backlight 103. The detection surface of the backlight sensor 105 is disposed inside the display apparatus 100 (e.g. inside the case of the backlight 103). For example, the backlight sensor 105 is a brightness sensor, and a detection value of the backlight sensor 105 (backlight detection value) indicates brightness (luminance).

As illustrated in FIG. 1B, a plurality of backlight sensors 105 may be disposed in the backlight 103, for example.

An image signal (input image signal) is inputted from the input signal source 50 to the display control unit 101. The display control unit 101 controls the aperture ratio of each MEMS shutter of the MEMS shutter panel 102, based on the input image signal.

The external light detection value and the backlight detection value are inputted to the display control unit 101. The display control unit 101 corrects the backlight detection value based on the input image signal and the external light detection value, and controls the amount of luminescence of the backlight 103 based on the backlight detection value after correction. For example, the display control unit 101 controls the amount of luminescence of the backlight 103 so that change and unevenness of brightness of the backlight 103 are reduced.

The display control unit 101 may control the amount of luminescence of the backlight 103 based on the input image signal, so that the brightness of the backlight 103 becomes a brightness based on the input image signal.

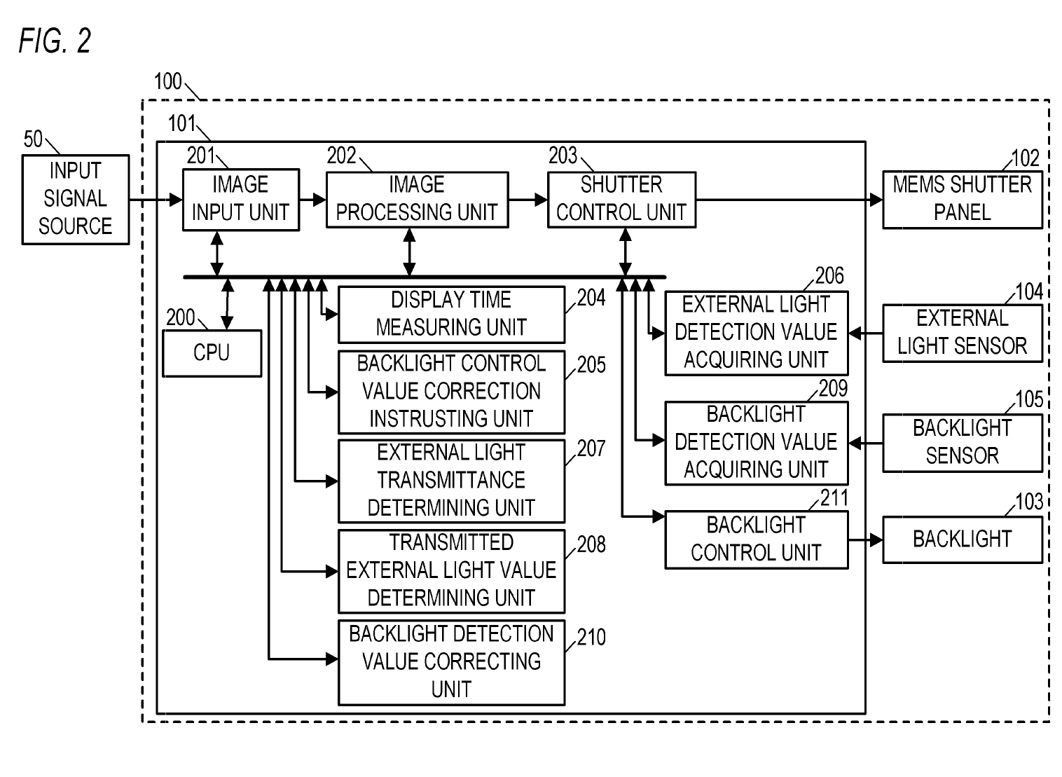

FIG. 2 is a block diagram depicting an example of a configuration of the display control unit 101.

The display control unit 101 includes a CPU 200, an image input unit 201, an image processing unit 202, a shutter control unit 203, a display time measuring unit 204, a backlight control value correction instructing unit 205, a external light detection value acquiring unit 206, a external light transmittance determining unit 207, a transmitted external light value determining unit 208, a backlight detection value acquiring unit 209, a backlight detection value correcting unit 210, and a backlight control unit 211.

A ROM and a RAM (not illustrated) are connected to the CPU 200. The CPU 200 controls operation of the display control unit 101 overall according to the programs stored in the ROM. The CPU 200 uses the RAM as a work memory. The CPU 200 includes a timer (not illustrated). The CPU 200 performs time management using the timer.

The image input unit 201 generates image data by decoding an image signal (input image signal) inputted from the input signal source 50. The image input unit 201 outputs the generated image data to the image processing unit 202.

The image processing unit 202 performs such image processing as image quality enhancement processing on the image data inputted from the image input unit 201. The image processing unit 202 outputs the image data after the image processing to the shutter control unit 203.

The shutter control unit 203 converts the image data inputted from the image processing unit 202 into shutter control information. The shutter control unit 203 outputs the shutter control information to the MEMS shutter panel 102 and the external light transmittance determining unit 207. The shutter control unit 203 outputs a vertical synchronizing signal of the image data (input image signal) to the external light detection value acquiring unit 206, the backlight detection value acquiring unit 209, and the backlight control unit 211. The shutter control information is an aperture ratio of each MEMS shutter (each pixel).

The MEMS shutter panel 102 drives each MEMS shutter according to the shutter control information inputted from the shutter control unit 203.

The display time measuring unit 204 measures the time that elapsed from the start of display of the image by the MEMS shutter panel 102 (display time) using the timer included in the CPU 200. For example, the display time measuring unit 204 measures the elapsed time from the time when the display of the image was started by the MEMS shutter panel 102 (this time is regarded as “0”) to the current time.

During measurement of the display time, the display time measuring unit 204 outputs the measured value (elapsed time from the time when the display of the image was started to the current time) to the backlight control value correction instructing unit 205.

When the display time measured by the display time measuring unit 204 reaches a predetermined threshold, the backlight control value correction instructing unit 205 outputs a external light detection value acquisition instruction to the external light detection value acquiring unit 206, and outputs a backlight detection value acquisition instruction to the backlight detection value acquiring unit 209. Then the backlight control value correction instructing unit 205 outputs a backlight control value correction instruction to the external light transmittance determining unit 207. The predetermined threshold mentioned above is a time from the start of the display of the image to the stabilization of the temperature of the backlight, for example, and is stored in the ROM in advance. The backlight control value is a value that indicates the amount of luminescence of the backlight.

The external light detection value acquiring unit 206 acquires a external light detection value from the external light sensor 104 at a timing of a vertical synchronizing signal of the input image signal in response to the input of the external light detection value acquisition instruction from the backlight control value correction instructing unit 205. Then the external light detection value acquiring unit 206 outputs the external light detection value to the transmitted external light value determining unit 208.

The external light transmittance determining unit 207 determines the external light transmittance based on the input image signal. In this embodiment, the external light transmittance determining unit 207 determines the external light transmittance based on the shutter control information. The processing to determine the external light transmittance is performed in response to the backlight control value correction instruction from the backlight control value correction instructing unit 205. Then the external light transmittance determining unit 207 outputs the external light transmittance to the transmitted external light value determining unit 208. The external light transmittance is the transmittance when the external light transmits through the display panel. In the present embodiment, the external light transmittance is determined based on the aperture ratio of each MEMS shutter.

The transmitted external light value determining unit 208 determines the transmitted external light value based on the input image signal and the external light detection value. In the present embodiment, when the external light detection value and the external light transmittance are inputted, the transmitted external light value determining unit 208 determines the transmitted external light value based on the inputted information, and outputs the transmitted external light value to the backlight detection value correcting unit 210. The external light transmits into the display apparatus via the display panel. The transmitted external light value is a value of the external light after being transmitted into the display apparatus. In the present embodiment, the transmitted external light value is a value acquired by multiplying the external light transmittance by the external light detection value.

The backlight detection value acquiring unit 209 acquires the backlight detection value from the backlight sensor 105 at the timing of the vertical synchronizing signal of the input image signal in response to the input of the backlight detection value acquisition instruction from the backlight control value correction instructing unit 205. Then the backlight detection value acquiring unit 209 outputs the backlight detection value to the backlight detection value correcting unit 210.

The backlight detection value correcting unit 210 corrects the backlight sensor detection value based on the input image signal and the external light detection value, so that the change of the detection value of the backlight sensor, due to the external light that transmits into the display apparatus via the display panel, reduces. In the present embodiment, the backlight detection value correcting unit 210 corrects the backlight detection value inputted from the backlight detection value acquiring unit 209, based on the transmitted external light value inputted from the transmitted external light value determining unit 208. Then the backlight detection value correcting unit 210 outputs the backlight detection value after the correction to the backlight control unit 211.

The backlight control unit 211 controls the amount of luminescence of the backlight 103 based on the backlight detection value after the correction by the backlight detection value correcting unit 210. In the present embodiment, the backlight control unit 211 corrects the backlight control value, based on the backlight detection value after the correction, and the target value, so that the backlight detection value after the correction matches with the target value. Then the backlight control unit 211 outputs the backlight control value after the correction to the backlight 103. The target value may be a fixed value or may be determined based on the input image signal. The target value is, for example, a backlight detection value acquired in advance under conditions where the external light does not influence the backlight detection value, or a value calculated based on such a backlight detection value. The backlight detection value acquired in advance under conditions where the external light does not influence the backlight detection value has been stored in the ROM.

As mentioned above, the backlight control value is a value that indicates an amount of luminescence of the backlight. The backlight 103 drives the light source of the backlight 103 according to the backlight control value inputted from the backlight control unit 211.

In the present embodiment, it is assumed that the backlight detection value is higher as the amount of luminescence of the backlight is higher under conditions where the external light does not influence the backlight detection value. It is also assumed that the amount of luminescence is higher as the backlight control value is higher. In this case, the backlight control value can be increased when the backlight detection after the correction is lower than the target value, and the backlight control value can be reduced when the backlight detection value after the correction is higher than the target value. By repeating this processing, feedback control to reduce change and unevenness of the brightness of the backlight can be implemented. The correction quantity (adjustment quantity) of the backlight control value can be determined based on the difference between the backlight detection value after the correction and the target value, for example. The amount of luminescence of the backlight can be adjusted by adjusting the lighting time of each light source and the electric current applied to each light source.

The relationship between the amount of luminescence and the back detection value, and the relationship between the backlight control value and the amount of luminescence are not limited to the above mentioned relationships. The backlight detection value may be lower as the amount of luminescence is higher. The amount of luminescence may be lower as the backlight control value is higher.

The method of correcting the backlight control value is not limited to the above mentioned method. For example, the backlight control value after the correction may be calculated by a computation using the backlight detection value after the correction and the target value.

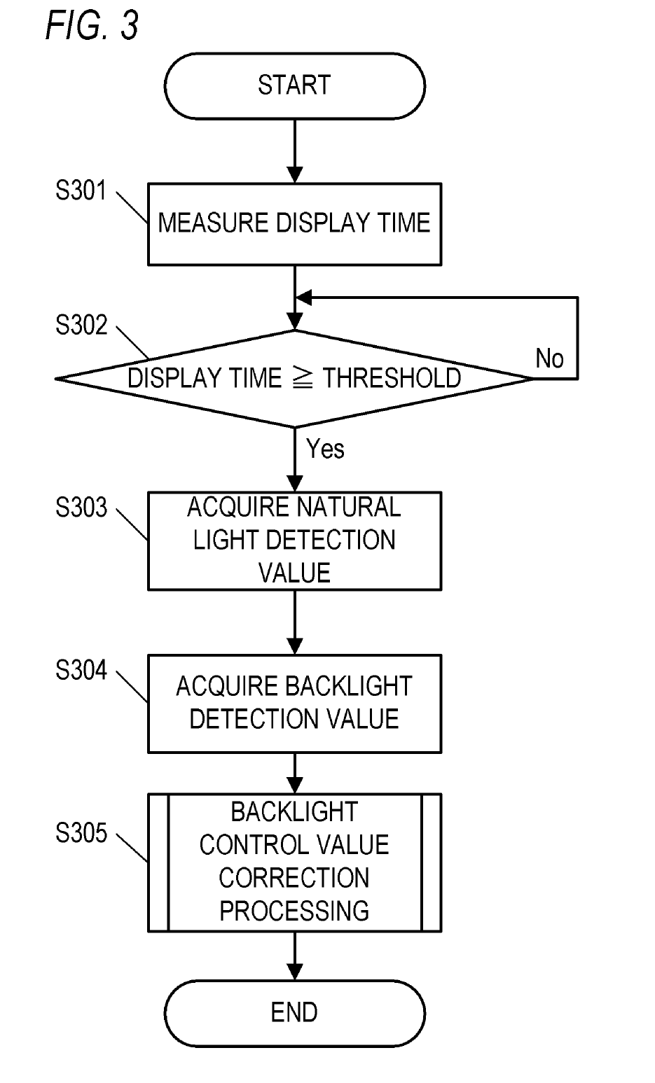

The operation of the display control unit 101 will be described with reference to the flow chart in FIG. 3. The start of the operation in the flow chart in FIG. 3 is triggered by the user operation that turns the power of the display apparatus ON.

First the display time measuring unit 204 measures the elapsed time since the time when the power of the display apparatus is turned ON, and outputs the measured value to the backlight control value correction instructing unit 205 (S301).

Then the backlight control value correction instructing unit 205 stands by until the display time reaches a predetermined threshold (S302). When the display time reaches the predetermined threshold, processing advances to S303.

In S303, the backlight control value correction instructing unit 205 outputs the external light detection value acquiring instruction to the external light detection value acquiring unit 206. The external light detection value acquiring unit 206 acquires a external light detection value I(t) at time t from the external light sensor 104 at the timing of the vertical synchronizing signal of the input image signal in response to the input of the external light detection value acquisition instruction. Then the external light detection value acquiring unit 206 outputs the external light detection value I(t) to the transmitted external light value determining unit 208.

Then the backlight control value correction instructing unit 205 outputs the backlight detection value acquisition instruction to the backlight detection value acquiring unit 209 (S304). The backlight detection value acquiring unit 209 acquires a backlight detection value L(t) at time t from the backlight sensor 105 at the timing of the vertical synchronizing signal of the input image signal in response to the input of the backlight detection value acquisition instruction. Then the backlight detection value acquiring unit 209 outputs the backlight detection value L(t) to the backlight detection value correcting unit 210.

Then the backlight control value correction instructing unit 205 outputs the backlight control value correction instruction to the external light transmittance determining unit 207 (S305). Thereby the processing to correct the backlight control value (backlight control value correction processing) is performed.

In the flow chart in FIG. 3, the display time is the elapsed time since the time when the power of the display apparatus 100 is turned ON, but the display time is not limited to this. For example, the display time may be the elapsed time since the time when the output of the shutter control information from the shutter control unit 203 to the MEMS shutter panel 102 is started. The display time may also be the elapsed time since the time when the user operation to display the image is executed. Further, only the elapsed time since the display start time of the first image may be measured as the display time, or every time an image to be displayed is switched, the elapsed time since the display start time of the switched image may be measured as the display time.

According to the flowchart in FIG. 3, the processing in S303 to S305 is not executed more than once while the power of the display apparatus is ON. However the execution frequency of the processing in S303 to S305 is not limited to this. For example, the processing in S303 to S305 may be executed regardless the display time. The processing in S303 to S305 may be executed in response to the user operation to execute the backlight control value correction processing. The processing in S303 to S305 may be executed at predetermined intervals when the display apparatus is being used.

A temperature sensor to detect the temperature of the backlight may be disposed in the display apparatus, so that whether the processing in S303 to S305 is executed or not is determined based on the detection value of the temperature sensor (temperature of the backlight). For example, in the pre sent embodiment, whether the temperature of the backlight is stabilized or not is determined based on the display time, but whether the temperature of the backlight is stabilized or not may be determined based on the detection value of the temperature sensor. Then the processing in S303 to S305 may be executed, triggered by the determination that the temperature of the backlight is stabilized. Whether the temperature of the backlight has been changed by a predetermined threshold or higher from the temperature when the backlight control value correction processing was executed last, may be determined based on the detection value of the temperature sensor. Then the processing in S303 to S305 may be executed, triggered by the determination that the temperature of the backlight has been changed by a predetermined threshold or higher from the temperature when the backlight control value correction processing was executed last.

When the MEMS shutter is closed, the external light that transmits into the display apparatus is less than the time when the MEMS shutter is open. In other words, the influence of the external light on the backlight detection value is less as the time when the MEMS shutter is closed is longer. Therefore the processing in S303 to S305 may be executed only when the time required for the backlight sensor to acquire the backlight detection value is shorter than the time when the MEMS shutter is closed.

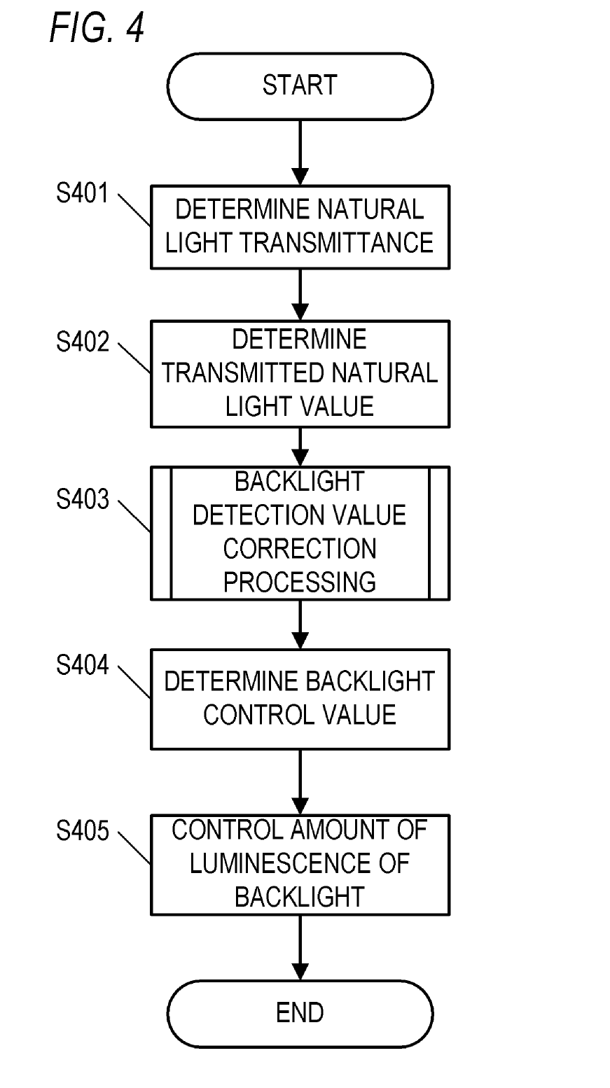

The backlight control value correction processing will be described in detail with reference to the flow chart in FIG. 4.

First the external light transmittance determining unit 207 determines a pixel external light transmittance P_{g} at time t for each pixel of the display panel, based on the input image signal. In concrete terms, for each pixel, the external light transmittance determining unit 207 determines the pixel external light transmittance P_{g} at time t based on the inputted shutter control information, using a pixel external light transmittance table which is provided in advance. The external light transmittance determining unit 207 determines the representative value (e.g. mean value, mode, median value, minimum value, maximum value) of the pixel external light transmittance P_{g} of each pixel, as a external light transmittance Pₐᵣₑₐ at time t. Then the external light transmittance determining unit 207 outputs the determined external light transmittance Pₐᵣₑₐ area to the transmitted external light value determining unit 208 (S401). The representative value of the pixel external light transmittance of all the pixels of the display panel may be determined as the external light transmittance. However, it is preferable not to consider the external light transmitted through pixels distant from the backlight sensor 105, since influence on the backlight detection value is minor (considering of such pixels cause deviation of the external light transmittance from an optimum value). Therefore in the present embodiment, the external light transmittance determining unit 207 determines, as the external light transmittance, a representative value of the pixel external light transmittance values of pixels within a predetermined range from the backlight sensor on a surface in parallel with the screen, out of the plurality of pixels of the display panel. By using only the pixel external light transmittance values of the pixels near the backlight sensor 105, an optimum value as the external light transmittance can be acquired. If nine backlight sensors 105 are disposed in the backlight 103, as illustrated in FIG. 1B, then a representative value of the pixel external light transmittance values of pixels located in an area (area of the light emitting surface; area on the screen) corresponding to the backlight sensor (2, 2) can be determined as the external light transmittance.

The pixel external light transmittance is transmittance when the external light transmits through the pixel. For example, the pixel external light transmittance is a value acquired by multiplying the light utilization efficiency of the display panel by the aperture ratio of the pixel corresponding to the pixel external light transmittance. In the case of a MEMS shutter system in which red (R), green (G) and blue (B) backlights are sequentially lit by time division, a mean value of an aperture ratio corresponding to red, an aperture ratio corresponding to green, and an aperture ratio corresponding to blue is used. In concrete terms, a value acquired by multiplying the light utilization efficiency of the display panel by the mean value is used as the pixel external light transmittance. The light utilization efficiency here refers to a ratio of the light emitted from the display panel (light of the backlight after being transmitted through the display panel) with respect to the light from the backlight when the aperture ratio of the display panel (display elements of the display panel) is at the maximum.

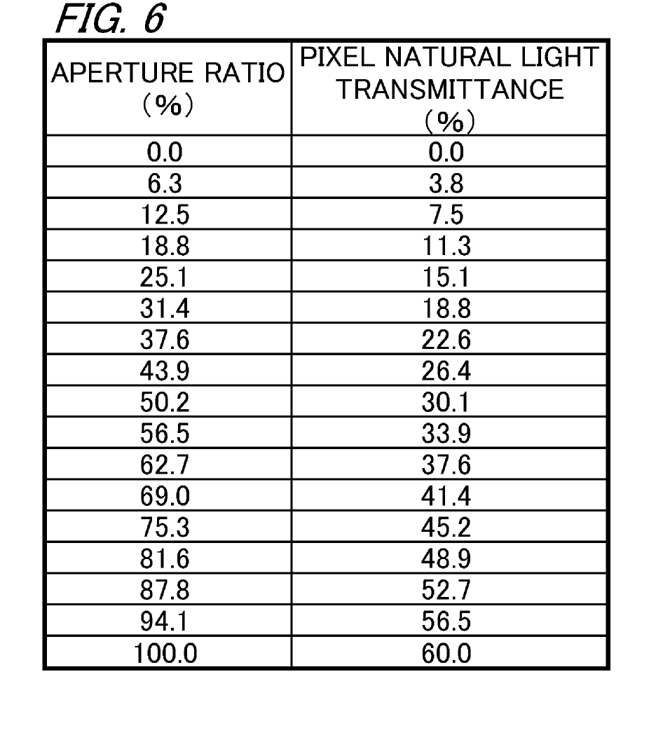

The pixel external light transmittance table is a table that indicates a correspondence between the aperture ratio and the pixel external light transmittance, as shown in FIG. 6. For example, the aperture ratios S₁, S₂, . . . , Sₐ, Sₐ₊₁, . . . , S_{end} and the pixel external light transmittance P₁, P₂, . . . , Pₐ, Pₐ₊₁, . . . , P_{end} are corresponded to each other in a table. In the example in FIG. 6, a value acquired by multiplying the aperture ratio by the light utilization efficiency of the standard MEMS shutter, which is 60%, is written as the pixel external light transmittance. The light utilization efficiency of the display panel may be lower or higher than 60%.

For a pixel of which corresponding aperture ratio S_{g} is written in the pixel external light transmittance table, a pixel external light transmittance Pₙ (n=1 to end) corresponding to the aperture ratio S_{g} is acquired from the pixel external light transmittance table as the pixel external light transmittance P_{g}. For a pixel of which corresponding aperture ratio S_{g} is not written in the pixel external light transmittance table, the pixel external light transmittance P_{g} is calculated by interpolation processing using the aperture ratio and the pixel external light transmittance written in the pixel external light transmittance table. The pixel external light transmittance P_{g} can be calculated using the following Expression 1 (linear interpolation formula). In Expression 1, Sₐ<S_{g}<Sₐ₊₁. The method of determining the pixel external light transmittance P_{g} for a pixel, of which corresponding aperture ratio S_{g} is not written in the pixel external light transmittance table, is not limited to this. For example, the pixel external light transmittance corresponding to an aperture ratio closest to the aperture ratio S_{g}, out of the aperture ratios written in the pixel external light transmittance table, may be acquired as the pixel external light transmittance P_{g}. An approximate function (approximate line or approximate curve) that expresses the relationship between the aperture ratio and the pixel external light transmittance may be calculated based on the aperture ratio and the pixel external light transmittance written in the pixel external light transmittance table, so that the pixel external light transmittance P_{g} is calculated from the approximate function.

$$\begin{matrix}[ Math . 1 ] & \\ \frac{{P}_{a + 1} - {P}_{a}}{{S}_{a + 1} - {S}_{a}} \times ( {S}_{g} - {S}_{a} ) + {P}_{a} = {P}_{g} & ( Expression 1 )\end{matrix}$$

If the predetermined range is a range of x pixels in the horizontal direction×y pixels in the vertical direction, the external light transmittance determining unit 207 calculates the mean value of the pixel external light transmittance P_{g} of each pixel in the predetermined range as the external light transmittance Pₐᵣₑₐ using the following Expression 2, for example.

$$\begin{matrix}[ Math . 2 ] & \\ \frac{Σ {P}_{g}}{x \times y} = {P}_{area} & ( Expression 2 )\end{matrix}$$

After S401, the transmitted external light value determining unit 208 calculates the transmitted external light value T_{g} at time t using the following Expression 3. In other words, the transmitted external light value determining unit 208 calculates the transmitted external light value T_{g} by multiplying the external light detection value I(t) by the external light transmittance Pₐᵣₑₐ. Then the transmitted external light value determining unit 208 outputs the transmitted external light value T_{g} to the backlight detection value correcting unit 210 (S402).

[Math. 3]

I(t)×Pₐᵣₑₐ=T_{g} (Expression 3)

Then the backlight detection value correcting unit 210 corrects the backlight detection value L(t) based on the transmitted external light value T_{g}, and outputs the backlight detection value Lc(t) after the correction to the backlight control unit 211 (S403: backlight detection value correcting processing).

Then the backlight control unit 211 calculates a backlight control value (after the correction) from the backlight detection value Lc(t) after the correction and the target value (S404).

Then the backlight control unit 211 outputs (sets) the backlight control value calculated in S404 to the backlight (S405). Thereby the amount of luminescence of the backlight is controlled.

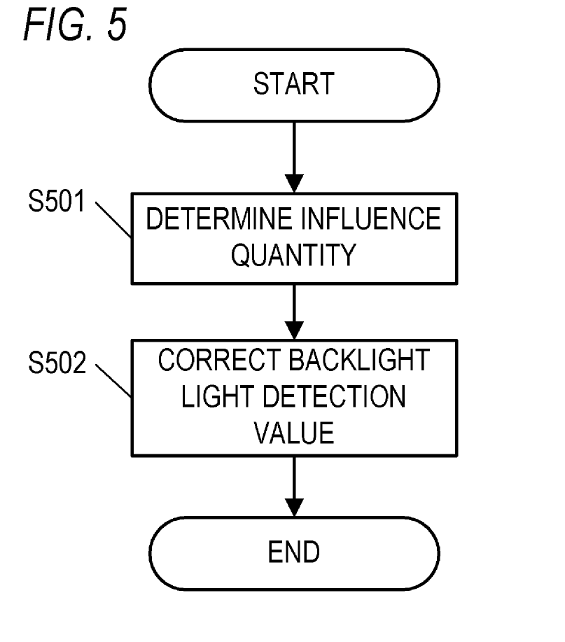

The backlight detection value correction processing will be described in detail with reference to the flow chart in FIG. 5.

First the backlight detection value correcting unit 210 determines the influence quantity of the external light on the backlight detection value based on the transmitted external light value determined by the transmitted external light value determining unit. In concrete terms, the backlight detection value correcting unit 210 determines the influence quantity N_{g} of the external light on the backlight detection value L(t) from the inputted transmitted external light value T_{g} using an influence quantity table provided in advance (S501). In the present embodiment, this processing may be executed by a functional unit other than the backlight detection value correcting unit 210 (e.g. influence quantity determining unit, which is not illustrated).

The unit of the transmitted external light is the same as the unit of the external light detection value (e.g. illuminance), for example.

The influence quantity is a value generated by converting the transmitted external light into the backlight detection value (e.g. brightness), for example.

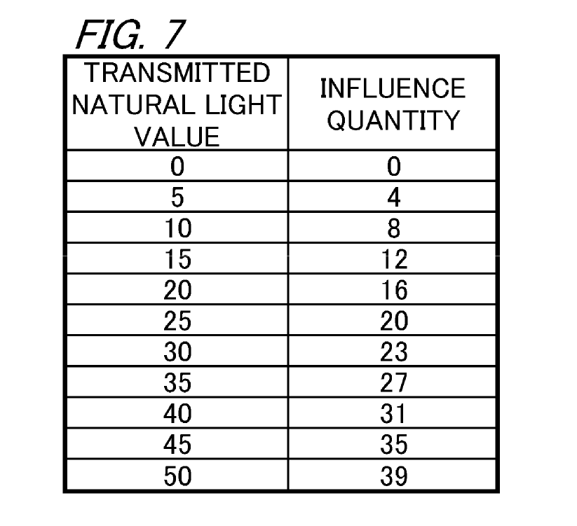

The influence quantity table is a table that indicates the correspondence between the transmitted external light value and the influence quantity, as shown in FIG. 7. For example, the transmitted external light values T₁, T₂, . . . , Tₐ, Tₐ₊₁, . . . , T_{end} and the influence quantity N₁, N₂, . . . , Nₐ, Nₐ₊₁, . . . , N_{end} are corresponded to each other in a table. In the example in FIG. 7, a value acquired by multiplying the transmitted external light value by a conversion efficiency (conversion coefficient) from the transmitted external light value to the backlight detection value, which is 78%, is written as the influence quantity. The conversion efficiency from the transmitted external light value to the backlight detection value may be lower or higher than 78%.

If the transmitted external light value T_{g} is written in the influence quantity table, the influence quantity Nₙ (n=1 to end) corresponding to the transmitted external light value T_{g} can be acquired as influence quantity N_{g} from the influence quantity table. If the transmitted external light value T_{g} is not written in the influence quantity table, the influence quantity N_{g} is calculated by interpolation processing using the transmitted external light value and the influence quantity written in the influence quantity table. The influence quantity N_{g} can be calculated using the following Expression 4 (linear interpolation formula). In Expression 4, Tₐ<T_{g}<Tₐ₊₁. The method of determining the influence quantity N_{g} of which transmitted external light value T_{g} is not written in the influence quantity table is not limited to this. For example, the influence quantity corresponding to a transmitted external light value closest to the transmitted external light value T_{g}, out of the transmitted external light values written in the influence quantity table may be acquired as the influence quantity N_{g}. An approximate function (approximate line or approximate curve) that expresses the relationship between the external light transmittance and the influence quantity may be calculated based on the external light transmittance and the influence quantity written in the influence quantity table, so that the influence quantity N_{g} is calculated from the approximate function.

$$\begin{matrix}[ Math . 4 ] & \\ \frac{{N}_{a + 1} - {N}_{a}}{{T}_{a + 1} - {T}_{a}} \times ( {T}_{g} - {T}_{a} ) + {N}_{a} = {N}_{g} & ( Expression 4 )\end{matrix}$$

After S501, the backlight detection value correcting unit 210 corrects the backlight detection value L(t) based on the influence quantity N_{g} (S502). In this embodiment, under conditions when the external light does not influence the backlight detection value, the backlight detection value is higher as the amount of luminescence of the backlight is higher, and the backlight detection value increases if influenced by the external light. The influence quantity is a value acquired by converting the transmitted external light value into the backlight detection value. Therefore in the present embodiment, the backlight detection value correcting unit 210 calculates the backlight detection value Lc(t) after the correction by subtracting the influence quantity N_{g} from the backlight detection value L(t). By subtracting the influence quantity N_{g} from the backlight detection value L(t), the backlight detection value Lc(t), from which the influence of the external light is removed, can be acquired.

As mentioned above, according to the present embodiment, the detection value of the backlight sensor can be corrected considering not only the detection value of the external light sensor, but also the transmittance of the display panel (to be more specific, the input image signal). Thereby the influence of the external light on the detection value of the backlight sensor can be accurately reduced, and the light from the backlight can be accurately detected. As a consequence, the amount of luminescence of the backlight can be accurately controlled.

In the present embodiment, the pixel external light transmittance P_{g} is determined using the pixel external light transmittance table, but the method of determining the pixel external light transmittance P_{g} is not limited to this. For example, the pixel external light transmittance P_{g} may be calculated using a relational expression (relational expression between the pixel external light transmittance and the aperture ratio) provided in advance.

In the present embodiment, the external light transmittance Pₐᵣₑₐ is determined from the pixel external light transmittance P_{g}, but the method of determining the external light transmittance Pₐᵣₑₐ is not limited to this. For example, the external light transmittance Pₐᵣₑₐ may be determined based on the feature quantity (e.g. brightness histogram, maximum brightness, minimum brightness, modal brightness, average brightness, median brightness) of the input image signal. In concrete terms, the external light transmittance Pₐᵣₑₐ may be determined using a table or a function that expresses the relationship between the feature quantity of the input image signal and the external light transmittance. Thereby the external light transmittance Pₐᵣₑₐ can be directly acquired from the input image signal. For the feature quantity of the input image signal, the feature quantity of the entire image may be used, but it is preferable to use the feature quantity of the image within a predetermined range from the backlight sensor on the surface in parallel with the screen.

In the present embodiment, the transmitted external light value T_{g} is calculated by multiplying the external light transmittance Pₐᵣₑₐ by the external light detection value I(t), but the method of determining the transmitted external light value T_{g} is not limited to this. For example, the transmitted external light value T_{g} may be determined by using a table that expresses the relationship between the external light transmittance and the external light detection value. The transmitted external light value T_{g} may be determined based on the feature quantity of the input image signal and the external light detection value I(t). In concrete terms, the transmitted external light value T_{g} may be determined using a table or a function that expresses the relationship between the feature quantity of the input image signal, the external light detection value, and the transmitted external light value. Thereby the transmitted external light value T_{g} can be acquired without determining the pixel external light transmittance P_{g} and the external light transmittance Pₐᵣₑₐ.

In the present embodiment, the influence quantity N_{g} is determined using the influence quantity table, but the method of determining the influence quantity N_{g} is not limited to this. For example, the influence quantity N_{g} may be calculated from a relational expression (relational expression between the influence quantity and the transmitted external light value), which is provided in advance.

In the present embodiment, the backlight detection value Lc(t) after the correction is calculated based on the influence quantity N_{g} and the backlight detection value L(t), but the method of correcting the backlight detection value L(t) is not limited to this. For example, the backlight detection value Lc(t) after the correction may be determined using a table that expresses the relationship of the influence quantity, the backlight detection value before correction, and the backlight detection value after the correction. The backlight detection value L(t) may be corrected based on the feature quantity of the input image signal and the external light detection value I(t). In concrete terms, the backlight detection value Lc(t) after the correction may be determined using a table or a function that expresses the relationship of the feature quantity of the input image signal, the external light detection value, the backlight detection value before the correction, and the backlight detection value after the correction. Thereby the transmitted external light value T_{g} can be acquired without determining the pixel external light transmittance P_{g}, the external light transmittance Pₐᵣₑₐ, and the influence quantity N_{g}.

In the present embodiment, the transmitted external light value is a value acquired by multiplying the external light transmittance by the external light detection value, but the transmitted external light is not limited to this. The transmitted external light may be greater or lesser than the value acquired by multiplying the external light transmittance by the external light detection value.

In the present embodiment, the pixel external light transmittance is a value acquired by multiplying the light utilization efficiency of the display panel by the aperture ratio, but the pixel external light transmittance is not limited to this. The pixel external light transmittance may be greater or lesser than the value acquired by multiplying the light utilization efficiency of the display panel by the aperture ratio.

In the present embodiment, the influence quantity is a value acquired by converting the transmitted external light value into a detection value of the backlight sensor, but the influence quantity is not limited to this. For example, the influence quantity may be a correction coefficient by which the backlight detection value L(t) is multiplied.

The unit of the backlight detection value, the unit of the influence quantity, the unit of the external light detection value, and the unit of the transmitted external light value may be the same or different. The unit of the external light transmittance and the unit of the pixel external light transmittance may be the same or different.

In the present embodiment, one external light sensor 104 is disposed and a sensor value detected by one external light sensor 104 is used as the external light detection value I(t), but the external light detection value I(t) is not limited to this. For example, a plurality of external light sensors 104 is disposed, and a mean value of a plurality of sensor values detected by the plurality of external light sensors 104 may be used as the external light detection value (t). A weight wₙ (n=1, 2, . . . ) of the external light sensor may be held for each area n of the screen. Then the external light detection value I(t) may be calculated by multiplying the sensor value of each external light sensor by the weight wₙ and adding each sensor value multiplied by wₙ. The weight wₙ is determined based on the positional relationship between the plurality of backlight sensors 105 and the plurality of external light sensor 104.

### Embodiment 2

Embodiment 2 of the present invention will now be described. Differences of Embodiment 1 and Embodiment 2 will be mainly described hereinbelow.

FIG. 1A is a schematic diagram depicting an example of the configuration of a display apparatus according to the present embodiment.

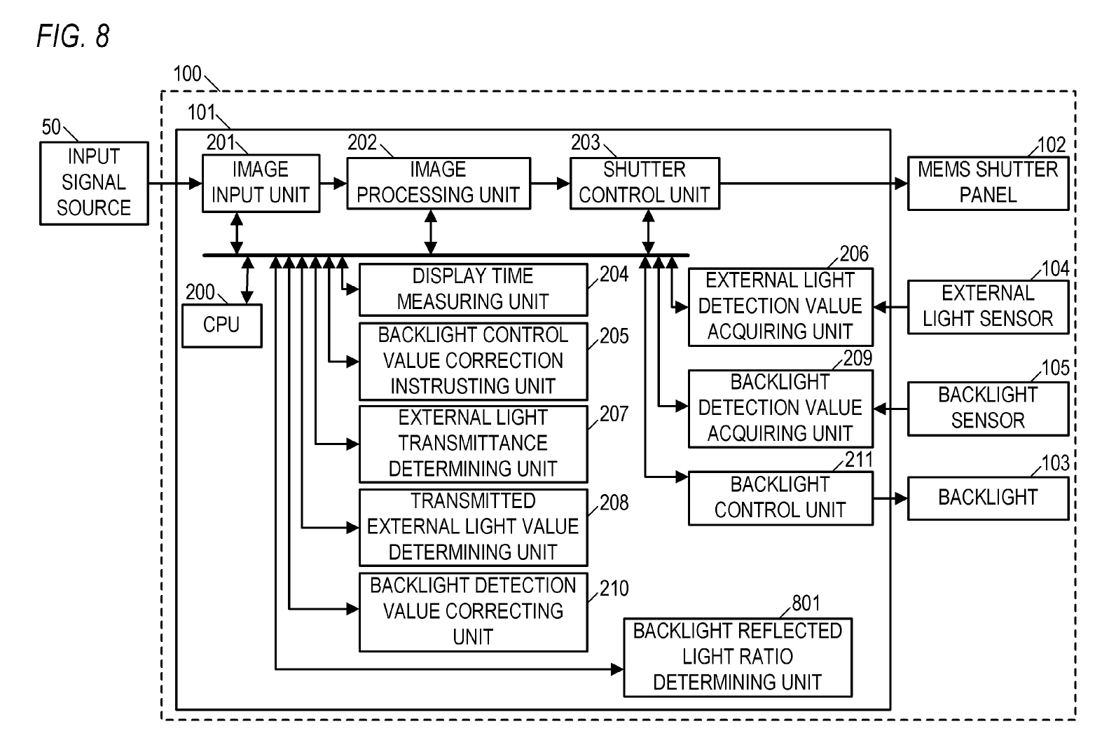

FIG. 8 is a block diagram depicting an example of a configuration of the display control unit 101.

The display control unit 101 includes a CPU 200, an image input unit 201, an image processing unit 202, a shutter control unit 203, a display time measuring unit 204, a backlight control value correction instructing unit 205, a external light detection value acquiring unit 206, a external light transmittance determining unit 207, a transmitted external light value determining unit 208, a backlight detection value acquiring unit 209, a backlight detection value correcting unit 210, a backlight control unit 211, and a backlight reflected light ratio determining unit 801.

The shutter control unit 203 outputs shutter control information to the MEMS shutter panel 102, the external light transmittance determining unit 207 and the backlight reflected light ratio determining unit 801.

The backlight reflected light ratio determining unit 801 determines a backlight reflected light ratio based on the shutter control information. Then the backlight reflected light ratio determining unit 801 outputs the backlight reflected light ratio to the backlight detection value correcting unit 210.

The backlight detection value correcting unit 210 corrects the backlight sensor detection value based on the input image signal, the external light detection value, and the backlight reflected light ratio. In concrete terms, the backlight detection value is corrected so as to reduce the change of the detection value due to the change of the reflected light of the backlight (light which is emitted from the backlight and returned to the backlight by being reflected by the MEMS shutter panel). In the present embodiment, the backlight detection value correcting unit 210 corrects the backlight detection value inputted from the backlight detection value acquiring unit 209, based on the transmitted external light value inputted from the transmitted external light value determining unit 208, and the backlight reflected light ratio inputted from the backlight reflected light ratio determining unit 801. Then the backlight detection value correcting unit 210 outputs the backlight detection value after the correction to the backlight control unit 211. For example, even if the amount of luminescence of the light source of the backlight 103 is constant, the reflected light ratio of the backlight 103 changes and the detection value of the backlight sensor 105 changes depending on the degree of opening of the shutter. Therefore the backlight detection value correcting unit 210 corrects the backlight detection value based on the backlight reflected light ratio.

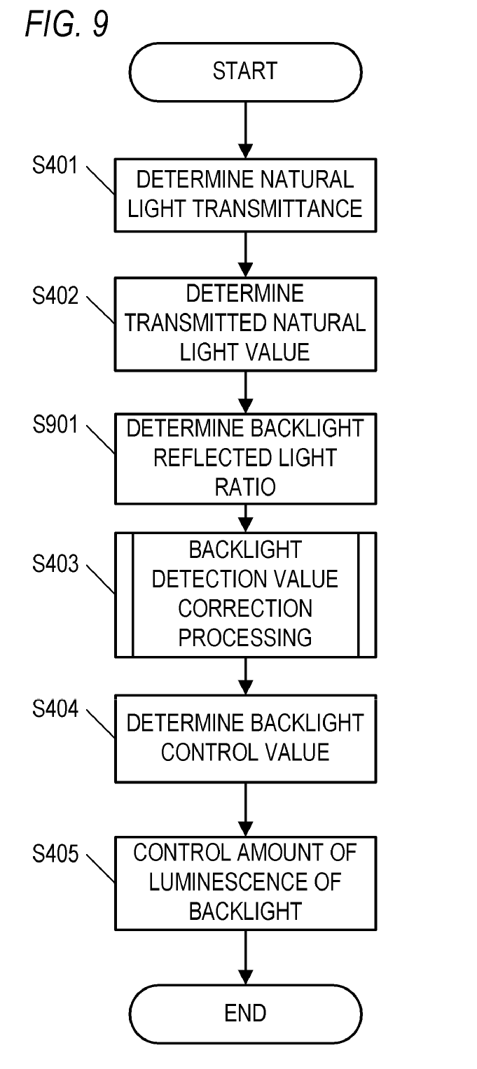

The backlight control value correction processing will now be described in detail with reference to the flow chart in FIG. 9.

First the processing in S401 and S402 is executed, just like Embodiment 1.

After S402, the backlight reflected light ratio determining unit 801 determines the backlight reflected light ratio based on the shutter control information (S901). The backlight reflected light ratio is a reflectance of the backlight which changes according to the open/close ratio of the MEMS shutter. The backlight reflected light ratio is a value acquired by multiplying the backlight reflected light ratio when the shutter is completely close (100%) by a light decreasing rate of the reflected light according to the aperture ratio of the shutter.

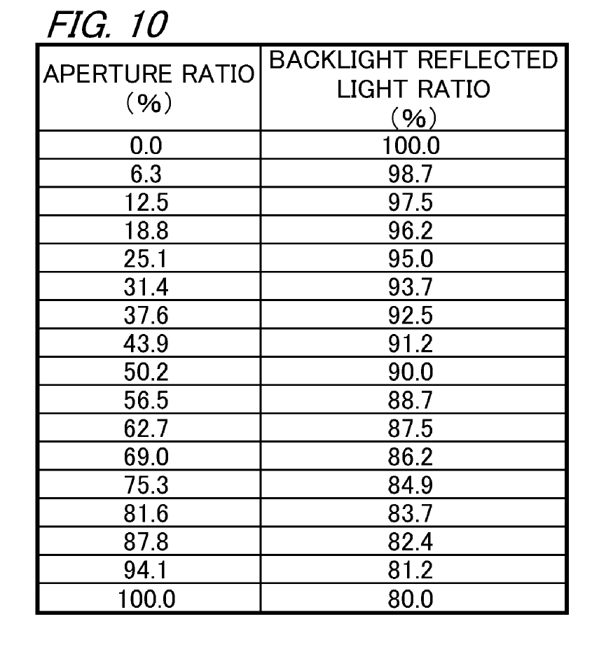

As shown in FIG. 10, the backlight reflected light ratio table is a table that expresses the correspondence between the aperture ratio and the backlight reflected light ratio. For example, the aperture ratios S₁, S₂, . . . , Sₐ, Sₐ₊₁, . . . , S_{end} and the backlight reflected light ratios R₁, R₂, . . . , Rₐ, Rₐ₊₁, . . . , R_{end} are corresponded with each other in the table. In the example in FIG. 10, if the aperture ratio is 100%, the backlight reflected light ratio decreases 20% compared with the case when the aperture ratio is 0%. The backlight reflected light ratio when the aperture ratio is 100% may be lower or higher than 80%.

For a pixel of which corresponding aperture ratio S_{g} is written in the backlight reflected light ratio table, the backlight reflected light ratio Rₙ (n=1 to end) corresponding to the aperture ratio S_{g} is acquired from the backlight reflected light ratio table as the backlight reflected light ratio R_{g}. For a pixel of which corresponding aperture ratio S_{g} is not written in the backlight reflected light ratio table, the backlight reflected light ratio R_{g} is calculated by an interpolation processing using the aperture ratio and the backlight reflected light ratio written in the backlight reflected light ratio table. The backlight reflected light ratio P_{g} can be calculated using the following Expression 5 (linear interpolation formula), for example. In Expression 5, Sₐ<S_{g}<Sₐ₊₁. The method of determining the backlight reflected light ratio R_{g} of a pixel of which corresponding aperture ratio S_{g} is not written in the backlight reflected light ratio table is not limited to this. For example, the backlight reflected light ratio corresponding to an aperture ratio closest to the aperture ratio S_{g}, out of the aperture ratios written in the backlight reflected light ratio table, may be acquired as the backlight reflected light ratio R_{g}. An approximate function (approximate line or approximate curve) that expresses the relationship between the aperture ratio and the backlight reflected light ratio may be calculated based on the aperture ratio and the backlight reflected light ratio written in the backlight reflected light ratio table, so that the backlight reflected light ratio R_{g} is calculated from the approximate function.

$$\begin{matrix}[ Math . 5 ] & \\ \frac{{R}_{a + 1} - {R}_{a}}{{S}_{a + 1} - {S}_{a}} \times ( {S}_{g} - {S}_{a} ) + {R}_{a} = {R}_{g} & ( Expression 5 )\end{matrix}$$

If the predetermined range is a range of x pixels in the horizontal direction×y pixels in the vertical direction, the backlight reflected light ratio determining unit 801 calculates the mean value of the backlight reflected light ratio R_{g} of each pixel in the predetermined range as the backlight reflected light ratio Rₐᵣₑₐ using the following Expression 6, for example.

$$\begin{matrix}[ Math . 6 ] & \\ \frac{Σ {R}_{g}}{x \times y} = {R}_{area} & ( Expression 6 )\end{matrix}$$

Then the backlight reflected light ratio determining unit 801 outputs Rₐᵣₑₐ to the backlight detection value correcting unit 210.

Then the backlight detection value correcting unit 210 corrects the backlight detection value L(t) based on the backlight reflected light ratio Rₐᵣₑₐ and the transmitted external light value T_{g}, and outputs the backlight detection value Lc(t) after the correction to the backlight control unit 211 (S403: backlight detection value correction processing).

Then the processing in S404 and S405 is executed, just like Embodiment 1.

The backlight detection value correction processing will be described in detail with reference to the flow chart in FIG. 5. Processing other than S502 is the same as Embodiment 1.

In S502, the backlight detection value correcting unit 210 corrects the backlight detection value L(t) based on the backlight reflected light ratio Rₐᵣₑₐ and the influence quantity N_{g}. In this embodiment, under conditions when the external light does not influence the backlight detection value, the backlight detection value is higher as the amount of luminescence of the backlight is higher, and the backlight detection value increases if influenced by the external light. The influence quantity is a value acquired by converting the transmitted external light value into the backlight detection value. Therefore in the present embodiment, the backlight detection value correcting unit 210 calculates the backlight detection value Lc(t) after the correction using the following Expression 7, for example. By subtracting the influence quantity N_{g} from the backlight detection value L(t), and multiplying the result by the backlight reflected light ratio, the backlight detection value Lc(t), from which the influence of the external light is removed, can be acquired.

[Math. 7]

(L(t)−N_{g})×Rₐᵣₑₐ=Lc(t) (Expression 7)

As described above, according to the present embodiment, the detection value of the backlight sensor is corrected considering not only the change of transmittance of the display panel due to the change of the open/close ratio of the display panel, but also the change of the reflected light ratio of the backlight due to the change of the open/close ratio of the display panel. Thereby the influence of the external light on the detection value of the backlight sensor can be accurately reduced and the light from the backlight can be accurately detected, regardless the open/close ratio of the display panel. As a consequence, the amount of luminescence of the backlight can be accurately controlled.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-270574, filed on Dec. 11, 2012, and Japanese Patent Application No. 2013-214562, filed on Oct. 15, 2013, which are hereby incorporated by reference herein in their entirety.

What is claimed is:

1. A display apparatus including a backlight and a display panel configured to transmit light from the backlight at a transmittance based on an input image signal,
the display apparatus comprising:
a backlight sensor configured to detect light from the backlight;
a external light sensor configured to detect external light of the display apparatus; and
a control unit configured to control an amount of luminescence of the backlight based on a detection value of the backlight sensor and a detection value of the external light sensor.

2. The display apparatus according to claim 1, further comprising a correcting unit configured to correct a detection value of the backlight sensor based on a detection value of the external light sensor, wherein
the control unit controls the amount of luminescence of the backlight based on the detection value after correction by the correcting unit.

3. The display apparatus according to claim 2, further comprising a transmitted external light value determining unit configured to determine a transmitted external light value, which is a value of external light after being transmitted into the display apparatus, based on the input image signal and a detection value of the external light sensor, wherein
the correcting unit corrects the detection value of the backlight sensor based on the transmitted external light value determined by the transmitted external light value determining unit.

4. The display apparatus according to claim 3, further comprising a external light transmittance determining unit configured to determine a external light transmittance, which is a transmittance when the external light transmits through the display panel, based on the input image signal, wherein
the transmitted external light value determining unit determines a transmitted external light value based on the external light transmittance determined by the external light transmittance determining unit and the detection value of the external light sensor.

5. The display apparatus according to claim 4, wherein
the transmitted external light value determined by the transmitted external light value determining unit is a value acquired by multiplying the external light transmittance determined by the external light transmittance unit determining by the detection value of the external light sensor.

6. The display apparatus according to claim 4, wherein
the external light transmittance determining unit determines, for each pixel of the display panel, based on the input image signal, a transmittance when the external light transmits through the pixel, as a pixel external light transmittance, and determines a representative value of the pixel external light transmittance of each pixel as the external light transmittance.

7. The display apparatus according to claim 6, wherein
the external light transmittance determining unit determines, as the external light transmittance, a representative value of pixel external light transmittances of pixels located within a predetermined range from the backlight sensor on a surface in parallel with a screen, among a plurality of pixels of the display panel.

8. The display apparatus according to claim 4, wherein
the pixel external light transmittance determined by the external light transmittance determining unit is a value acquired by multiplying a utilization efficiency of light from the backlight of the display panel by an aperture ratio of a pixel corresponding to the pixel external light transmittance.

9. The display apparatus according to claim 3, further comprising an influence quantity determining unit configured to determine influence quantity of external light on a detection value of the backlight sensor based on the transmitted external light value determined by the transmitted external light value determining unit, wherein
the correcting unit corrects the detection value of the backlight sensor based on the influence quantity determined by the influence quantity determining unit.

10. The display apparatus according to claim 9, wherein
the influence quantity determined by the influence quantity determining unit is a value acquired by converting the transmitted external light value determined by the transmitted external light value determining unit into the detection value of the backlight sensor.

11. A method of controlling a display apparatus including a backlight, a display panel configured to transmit light from the backlight at the transmittance based on an input image signal, a backlight sensor configured to detect light from the backlight, and a external light sensor configured to detect external light of the display apparatus,
the method comprising:
acquiring a detection value of the backlight sensor and a detection value of the external light sensor; and
controlling an amount of luminescence of the backlight based on the detection value of the backlight sensor and the detection value of the external light sensor.

12. A display apparatus including a backlight and a display panel configured to transmit light from the backlight at a transmittance based on an input image signal,
the display apparatus comprising:
a backlight sensor configured to detect light from the backlight;
a external light sensor configured to detect external light of the display apparatus; and
a correcting unit configured to correct a detection value of the backlight sensor based on a detection value of the external light sensor.

13. A method of controlling a display apparatus including a backlight, a display panel configured to transmit light from the backlight at a transmittance based on an input image signal, a backlight sensor configured to detect light from the backlight, and a external light sensor configured to detect external light of the display apparatus,
the method comprising:
acquiring a detection value of the backlight sensor and a detection value of the external light sensor; and
correcting the detection value of the backlight sensor based on the detection value of the external light sensor.
